(19) United States
(12) Patent Application Publication
(10) Pub. No.: US 2009/0311906 A1
(43) Pub. Date: Dec. 17, 2009

(54) CABLE ASSEMBLY WITH JUMPER FUNCTION

(75) Inventors: YONG-JUN CHEN, Shenzhen (CN); XIAN-KUI SHI, Shenzhen (CN); CHUNG-YEN YANG, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/482,480

(22) Filed: Jun. 11, 2009

(30) Foreign Application Priority Data
Jun. 11, 2008 (CN) 200820301119.2

(51) Int. Cl. H01R 12/24

(52) U.S. Cl. 439/499

(57) ABSTRACT

A cable assembly, comprises a housing with a plurality of terminal receiving passages extending from a front surface to a rear surface thereof and arranged into an upper row and a lower row. A plurality of insulation displacement terminals are received into the corresponding terminal receiving passages; each insulation displacement terminal defines a connecting portion beyond the rear surface of the housing. A flat cable is defined by a plurality of conductors arranged side by side in a transverse direction and an insulative layer surrounding the conductors, and is pressed to the rear surface of the housing and insulation displacement connected with the insulation displacement terminals, each conductor of the flat cable electrically connects with two insulation displacement terminals in a vertical direction. And a cover is assembled to the housing and hold the flat cable to the housing.

### FIELD OF THE INVENTION

The present invention relates to cable assembly, particularly to a cable assembly having a simplified structure and easily to be assembled, and with a jumper function thereof.

### DESCRIPTION OF PRIOR ART

Currently, an elongate housing of a cable assembly usually defines a plurality of terminal passageways therein extending in a longitudinal direction. The terminal passageways are arranged into an upper row and a lower row in a vertical direction. Each terminal passageway of the upper row is in alignment with a corresponding terminal passageway of the lower row in a vertical direction. A plurality of terminals are received into the corresponding terminal passageways of the elongate housing. An electrically connecting between two terminals needs to an additional conductive wire which is soldered with two connecting portions of the above said two terminals. However, several pairs of terminals in a vertical direction all need a manual welding to achieve an electrically connecting between each pair of terminals. So, this assembling method between the terminals and cables of the cable assembly is troubled and waste a lot of assembling time.

TW Pat. No. 409978 issued on Oct. 21, 2000 discloses a flat cable connector assembly. The flat cable connector assembly comprises an insulative housing 4, a plurality of insulation displacement terminals 6 arranged into an upper row and a lower row and received into the insulative housing 4, a flat cable 7 with a plurality of conductors 70 insulation displacement contacted with the corresponding insulation displacement terminals 6 and a cover 5 covered to a rear face of the insulative housing 2 and positioned the flat cable 7 between the insulative housing 2 and the cover 5. Each insulation displacement terminal 6 electrically connects with a conductor 70 of the flat cable 7 through insulation displacement connection. However, each terminal 6 of the upper row is misalignment with the terminal 6 of the lower row. Thus, each conductor 70 of the flat cable 7 is only electrically connected with only a terminal 6. So the cable assembly does not a have a jumper function as the terminals 6 arrangement form in the insulative housing 4.

As discussed above, an improved cable assembly overcoming the shortages of existing technology is needed.

### SUMMARY OF THE INVENTION

Accordingly, an object of the present invention is to provide a cable assembly having a simple structure and easily to be assembled, and with a jumper function thereof.

In order to achieve the above-mentioned objects, a cable assembly, comprises a housing with a plurality of terminal receiving passages extending from a front surface to a rear surface thereof and arranged into an upper row and a lower row. A plurality of insulation displacement terminals are received into the corresponding terminal receiving passages; each insulation displacement terminal defines an engaging portion, a mating portion extending forwardly from the engaging portion and a connecting portion extending rearwardly from the engaging portion and beyond the rear surface of the housing. A flat cable is defined by a plurality of conductors arranged side by side in a transverse direction and an insulative layer surrounding the conductors, and is pressed to the rear surface of the housing and insulation displacement connected with the insulation displacement terminals, each conductor of the flat cable electrically connects with two insulation displacement terminals in a vertical direction. And a cover is assembled to the housing and hold the flat cable to the housing.

Other objects, features and advantages of the invention will be apparent from the following detailed description taken in connection with the accompanying drawings.

### BRIEF DESCRIPTION OF THE DRAWINGS

FIG. 1 is a perspective view of a cable assembly in accordance with the present invention;

FIG. 2 is an exploded, perspective view of the cable assembly of FIG. 1;

FIG. 3 is similar to FIG. 2, but viewed from another aspect;

FIG. 4 is a partial assembled, perspective view of the cable assembly of FIG. 3; and

FIG. 5 is a partial assembled, perspective view of the cable assembly of FIG. 4.

### DETAILED DESCRIPTION OF PREFERRED EMBODIMENTS

Reference will now be made to the drawing figures to describe the present invention in detail.

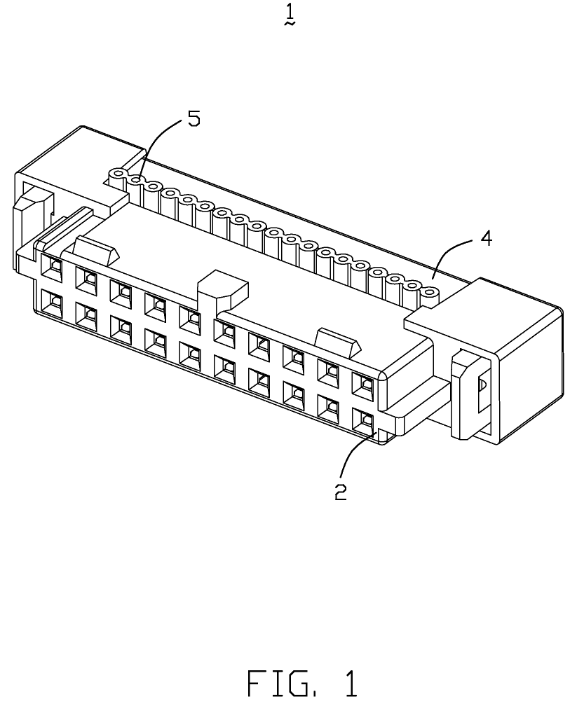

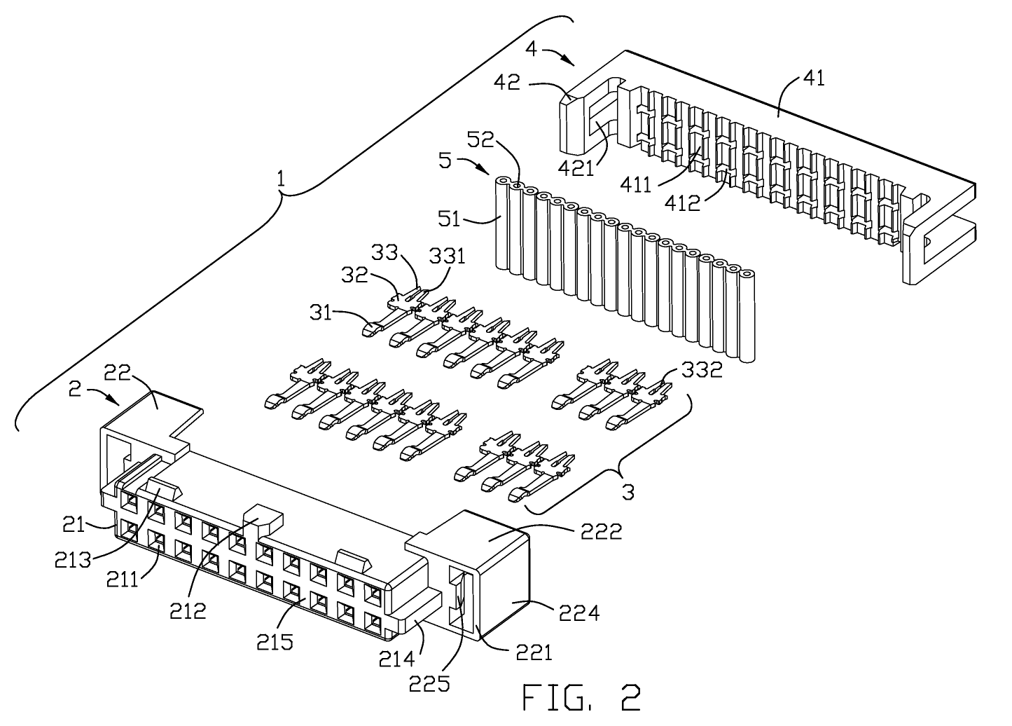

Referring to FIGS. 1 and 2, a cable assembly in accordance with the present invention, generally designated 1, is adapted for mating with a complementary connector (not shown). The cable assembly 1 comprises an insulative housing 2, a plurality of insulation displacement terminals 3 received into the insulative housing 2, a cover 4 assembled to a rear portion of the insulative housing 2 and a flat cable 5 electrically connected with the terminals 3 and disposed between the insulative housing 2 and the cover 4.

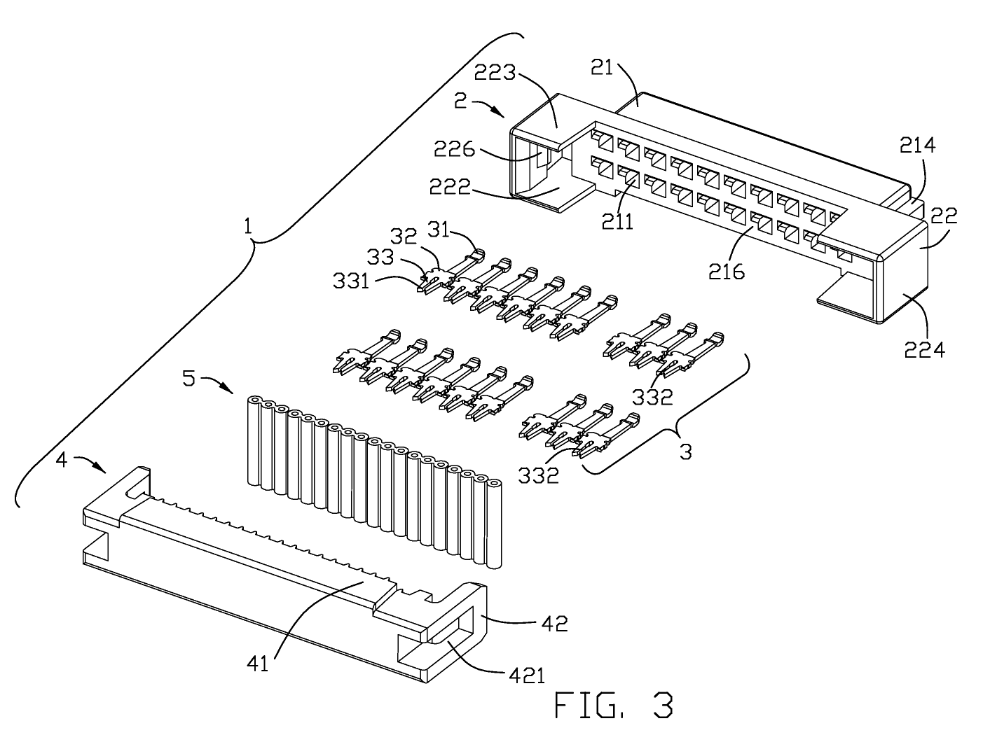

Referring to FIGS. 2 and 3, the insulative housing 2 defines an elongate mating portion 21 and a pair of wing portions 22 extending rearwardly and outwardly from outside surface of the mating portion 21.

The mating portion 21 of the insulative housing 2 has a front surface 215 and a rear surface 216 opposite to the front surface 215. The mating portion 21 of the insulative housing 2 defines a plurality of terminal receiving passages 211 therein extending rearwardly from the front surface 215 to the rear surface 216 of the mating portion 21. A plurality of terminal receiving passages 211 are arranged into a pair of upper and lower rows. Each receiving passage 211 of the upper row is in alignment with a corresponding receiving passage 211 of the lower row in a vertical direction. Each receiving passage 211 has a front opening and a rear opening respectively formed in a front surface 215 and a rear surface 216 of the mating portion 21 of the housing 2. The front opening is square and the rear opening is L-shaped. A trapezoidal guiding member 212 is formed on a top surface of the mating portion 21 of the housing 2 and for guiding the cable assembly 1 to the complementary connector. A pair of wedge-shaped engaging members 213 are also formed on the top surface of the mating portion 21 of the housing 2 and disposed at two sides of the trapezoidal guider member 212 and for locking with the complementary connector. Each engaging members 213 has an inclined front face and an inclined rear face opposite to the inclined front face. So, the cable assembly 1 is conveniently attached or deattached to the complementary connector. A pair of guiding posts 214 are respectively formed on two opposite side surfaces of the mating portion 21 of the insulative housing 2.

Each wing portion 22 has a front wall 221 extending laterally from a side surface of the mating portion 21 of the housing 2, a pair of upper and lower walls 222, 223 extending rearwardly from a top and a bottom side of the front wall 221 and respectively extending to the top and bottom surface of the mating portion of the housing 2 and a side wall 224 connected with the upper wall 222 and the lower wall 223. A channel is formed by the above said walls 221, 222, 223, 224. A rectangular hole is formed in the front wall 221. A wedge-shaped block 225 is formed on an inner face of the rectangular hole. A wedge-shaped block 226 is also formed on an inner face of the side wall 224.

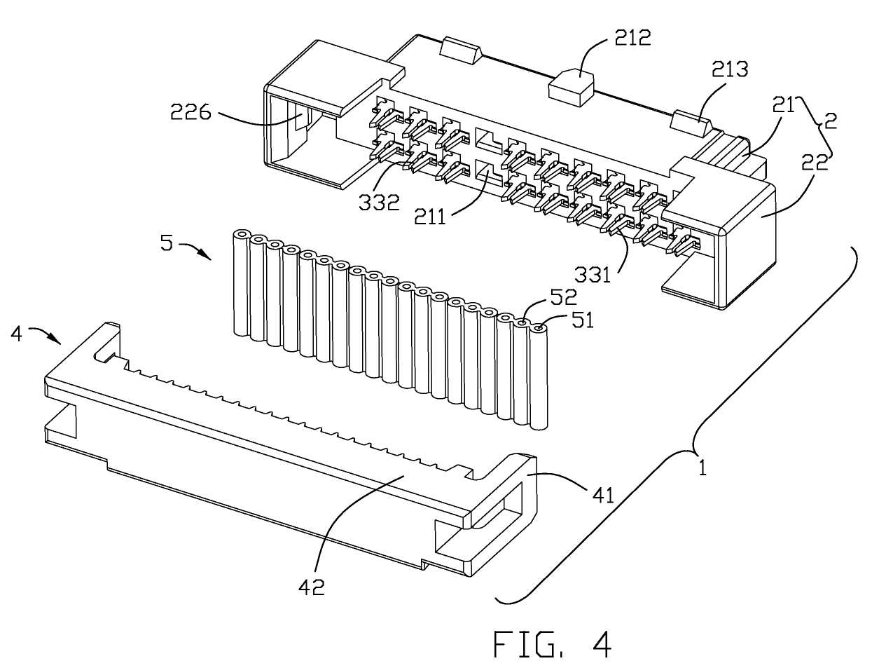

Referring to FIG. 2 to 4, a plurality of insulation displacement terminals 3 are arranged to two rows and respectively received into the corresponding terminal receiving passages 211. Each insulation displacement terminal 3 defines an engaging portion 32, a mating portion 31 extending forwardly from the engaging portion 32 and a connecting portion 32 extending rearwardly from the engaging portion 32. The connecting portion 32 defines a pair of insulation displacement blades 331 defining a slot 332 for receiving a conductor 52 of the flat cable 5.

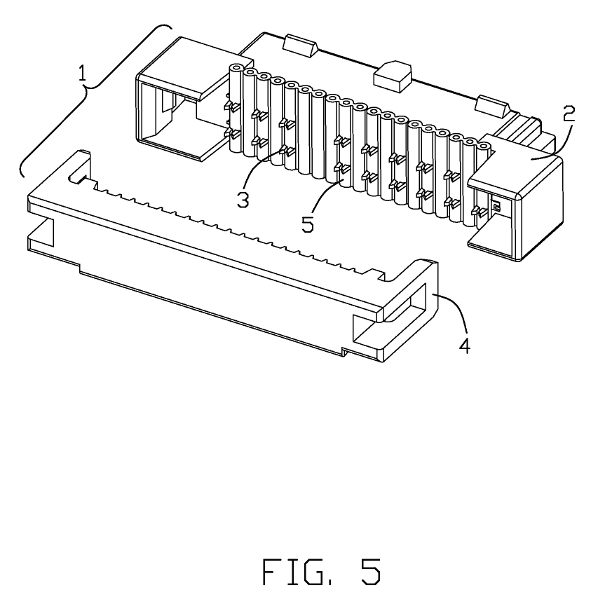

Referring to FIGS. 2 and 5, a flat cable 5 defines a plurality of conductors 52 arranged side by side in a transverse direction and an insulative layer 52 surrounding the conductors 52. Two adjacent conductors 52 are separated by the insulative layer 52.

Referring to FIGS. 2, the cover 4 has a base portion 41 and a pair of latching portion 42 extending forwardly from two sides of the base portion 41. The base portion 41 has a plurality of positioning slots 411 formed on a front surface thereof and arranged side by side in a transverse direction. Each positioning slot 411 extends from a top surface to a bottom surface of the base portion 41 in a up-to-down direction. Each positioning slot 411 has two recesses 412 arranged in vertical direction. Each latching portion 42 defines a hole 421 therein for receiving two wedge-shaped blocks 225, 226.

Referring to FIGS. 1 to 5, the assembling process of the cable assembly 1 in according to the present invention starts from assembling the insulation displacement terminals 3 into the insulative housing 2. The mating section 31 of the insulation displacement terminal 3 is received into a front end of the terminal receiving passage 211, the engaging portion 32 is engaged with a rear end of the terminal receiving passage 211 and the connecting portion 23 extends out of the rear surface 216 of the mating portion 21 of the insulative housing 2.

After the terminals 3 are assembled to the insulative housing 2, then assembling the flat cable 5 to the rear surface 216 of the mating portion 51 of the insulative housing 2 and electrically connected with the terminals 3. Insulative layer 51 surrounding a conductor 52 of the flat cable 2 is press-fitted into the slot 322, the insulative layer 51 of the flat cable 5 is pierced through by the inner sides of the pair of insulation displacement blades 331, and a pair of inner sides of the pair of insulation displacement blades 331 come in press-contact with the conductor 52 of the flat cable 5. When a front surface of the flat cable 5 attaches to the rear surface 216 of the mating portion 21 of the insulative housing 2, two rear ends of the pair of insulation displacement blades 331 are located beyond a rear surface of the flat cable 5.

At last, assembling the cover 4 to the insulative housing 2. The front surface of the base portion 41 of the cover 4 attaches to the rear surface of the flat cable 5. A rear half portion of the flat cable 5 is received into the a plurality of positioning slots 411 arranged side by side in a transverse direction. So, the flat cable 5 is received into a receiving space formed between the insulative housing 2 and the cover 4. Two rear ends of the pair of insulation displacement blades 33 1 are received into a recess 412. At this time, each latching portion 42 is received into the channel of the wing portion 22, and the wedge-shaped blocks 225, 226 are received into the hole 421 of the latching portion 42. So, the cover 4 is interlocked with the insulative housing 2.

Through the above assembling steps, the cable assembly 1 is accomplished. As the flat cable 5 electrically connects with the insulation displacement terminal 3 through insulation displacement connection, so the cable assembly 1 is easily and quickly assembled. In addition, one conductor 52 of the flat cable 5 of the cable assembly 1 is electrically connected with two insulation displacement terminals 3 in a vertical direction to achieve a jumper function. So, the cable assembly 1 overcomes the shortages of existing technology.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A cable assembly, comprising:
a housing with a plurality of terminal receiving passages extending from a front surface to a rear surface thereof and arranged into an upper row and a lower row;
a plurality of insulation displacement terminals received into the corresponding terminal receiving passages, each insulation displacement terminal defining an engaging portion, a mating portion extending forwardly from the engaging portion and a connecting portion extending rearwardly from the engaging portion and beyond the rear surface of the housing;
a flat cable defined by a plurality of conductors arranged side by side in a transverse direction and an insulative layer surrounding the conductors, and being pressed to the rear surface of the housing and insulation displacement connected with the insulation displacement terminals, each conductor of the flat cable electrically connecting with two insulation displacement terminals in a vertical direction; and
a cover assembled to the housing and hold the flat cable to the housing.

2. The cable assembly as recited in claim 1, wherein the housing defines a mating portion and a pair of wing portions extending rearwardly and outwardly from the mating portion, a receiving space is formed between the pair of the wing portions and the rear surface of the housing.

3. The cable assembly as recited in claim 2, wherein the cover defines a base portion and a pair of latching portions extending forwardly from two sides of the base portion, a portion of the flat cable and the base portion of latching portion are disposed in the receiving space.

4. The cable assembly as recited in claim 3, wherein the pair of latching portions of the cover engage with the pair of wing portions of the housing, a plurality of positioning slots formed on a front surface of the cover are fitting to

5. The cable assembly as recited in claim 1, wherein the mating portion of the insulation displacement terminal is received into a front end of the terminal receiving passage, the engaging portion is engaged with a rear end of the terminal receiving passage and the connecting portion extends out of the rear surface of the mating portion of the insulative housing.

6. The cable assembly as recited in claim 5, wherein the connecting portion defines a pair of insulation displacement blades defining a slot therebetween.

7. The cable assembly as recited in claim 6, wherein the insulative layer surrounding each conductor of the flat cable is press-fitted into the slot, the insulative layer of the flat cable is pierced through by the inner sides of the pair of insulation displacement blades, and a pair of inner sides of the pair of insulation displacement blades come in press-contact with the conductor of the flat cable.

8. The cable assembly as recited in claim 7, wherein a pair of rear ends of the pair of insulation displacement blades pass through the flat cable and are received into a recess formed on a positioning slot of the cover.

9. The cable assembly as recited in claim 1, wherein the housing defines a guiding member on a top surface thereof and a pair of guiding posts on two opposite side surfaces thereof.

10. The cable assembly as recited in claim 9, wherein a pair of engaging members are formed on a top surface of the housing and disposed at two sides of the pair of guiding members.

11. A cable assembly, comprising:
an insulative housing defining an upper and a lower row of terminal receiving passages therein extending from a front surface to a rear surface thereof,
an upper row and a lower row of terminals disposed in the corresponding terminal receiving passages with a plurality of connecting portions thereof beyond the rear surface of the insulative housing;
a flat cable formed by a plurality of conductors therein and an insulative layer surrounding the conductors, the flat cable being pressed to the rear surface of the insulative housing and insulation displacement connected with the connecting portions of the terminals, each conductor connecting with two connecting portions of an upper terminal and a lower terminal;
a cover engaged to the insulative housing and making the flat cable disposed between the cover and the insulative housing.

12. The cable assembly as recited in claim 11, wherein a rear end of each connecting portions of the terminal passes through the flat cable and received into a recess formed on a front surface of the cover.

13. The cable assembly as recited in claim 11, wherein the insulative housing defines a mating portion and a pair of wing portions extending rearwardly and outwardly from the mating portion, a receiving space is formed between the pair of the wing portions and the rear surface of the housing.

14. The cable assembly as recited in claim 13, wherein the connecting portions of the terminals, a portion of the flat cable and a base portion of the cover are disposed in the receiving space.

15. The cable assembly as recited in claim 13, the cover has a pair of latching portions engaged with the pair of wing portions of the insulative housing.

16. A cable connector assembly comprising:
an insulative housing defining two rows of passageways;
two rows of contacts received in the corresponding passageways, respectively;
a plurality of wires each including an inner conductor and an outer insulator coaxially; and
each of said contacts defining a mating section for mating with a terminal of a complementary connector, and a mounting section to electrically and mechanically connected to the conductor of the corresponding one of said wires; wherein
at least the mounting sections of the different two of said contacts are cooperatively electrically and mechanically connected to the same one of said wires.

17. The cable connector assembly as claimed in claim 16, wherein said two of the contacts are respectively located in said two rows while aligned with each other in a direction perpendicular to a row direction of said passageways.

18. The cable connector assembly as claimed in claim 17, wherein said wires are side by side arranged with one another along said row direction.

19. The cable connector assembly as claimed in claim 18, wherein said mounting section is an insulation displacement contact piercing through the outer insulator into the inner conductor.

20. The cable connector assembly as claimed in claim 19, wherein the wires each mechanically and electrically connected to the corresponding two contacts, and those without connection with any contacts are alternately arranged with each other in the row direction.
